(19) United States
(12) Patent Application Publication
(10) Pub. No.: US 2002/0195813 A1
(43) Pub. Date: Dec. 26, 2002

(54) Printed product and method for producing a printed product

(75) Inventor: Bernd Anton Hillebrand, Bergrheinfeld (DE)

Correspondence Address: Douglas R. Hanscom, JONES, TULLAR & COOPER, P.C., Eads Station, P.O. Box 2266, Arlington, VA, 22202, US

(73) Assignee: KOENIG & BAUER AKTIENGESELLSCHAFT

(21) Appl. No.: 10/229,164

(22) Filed: Aug. 28, 2002

Related U.S. Application Data
(62) Division of application No. 09/581,163, filed on Jun. 13, 2000.
Application No. 09/581,163 is a 371 of international application No. PCT/DE98/03697, filed on Dec. 16, 1998.

(30) Foreign Application Priority Data
Dec. 16, 1997 (DE) 19755691.4

(51) Int. Cl. B42D 19/00

(52) U.S. Cl. 281/5

(57) ABSTRACT

A printed product is produced on a web-fed rotary newspaper printing press. The dimensions of the resultant printed product can be varied. Paper webs of constant and preselected widths are combined with sub-paper webs of preselected and somewhat smaller widths. These webs are combined and are brought together.

The invention relates to a printed product in accordance with the preambles of claims 1, 9 and 14.

U.S. Pat. No. 4,901,993 A describes a method for producing a printed product which is easy to open. Here, material webs of different widths are conducted on top of each other and are subsequently transversely folded, so that a double page lying on the inside projects past a first page of the printed product.

The object of the invention is based on producing a printed product.

The invention has the following advantages in particular:

A continuously changeable total surface can be produced by means of a newspaper rotary printing press without changing the exterior formats of the product, for example a tabloid product of the sizes 420×289 mm.

Newspaper rotary printing presses known so far have the disadvantage that they can only produce fixed page skips, and therefore total surfaces which can only be changed in steps. If for example, a single width newspaper rotation with double cylinder circumference—a so-called eight page rotation—, is assumed, it is possible by means of this to produce page skips of two pages for broadsheets, four pages for tabloids, or eight pages for magazines (half the tabloid format) in double production.

In the more economical type of production “collection production”, the producible printed surfaces, or respectively page skips, known so far, are even more disadvantageous. It is only possible to produce skips of four pages for broadsheets, eight pages for tabloids or only sixteen pages for magazines.

The result of this is that the print shops are always forced, also editorially, to process the information for their newspaper and newspaper-like products in such a way that the page skips which can be produced are filled on the entire page. This necessity becomes more difficult, the larger the percentile change of the entire surface caused by the page skips becomes. For example, with a rotation of double the circumference, the change for a 16-page tabloid product is 25% in double production and in collection production even 50%. These large page skips can often not be sensibly produced editorially, even with the most modern software systems—such as an automatic letter size adaptation, for example, which “compresses” a defined amount of information into a defined number of pages—, so that in these cases it is very often necessary to do completely without an investment in the more economical rotations with double cylinder circumferences, or that these must be at least operated in double production.

A further economical disadvantage of these whole page printed surface skips are the paper costs which, in connection with a newspaper or newspaper-like product, makes a significant difference at approximately 30%.

If, for example, the editing staff perceives the possibility, or respectively the necessity, to include an additional whole-page advertisement in the product, it is necessary to create additional “filler pages” for producing this. This means that higher paper costs than would actually be necessary must be accepted. The situation is even more serious in the market of free newspapers, which are primarily specializing in small private ads and scarcely have editorial “filler pages”.

The invention now consists in that, for example in a double-width rotation for the production of newspapers or newspaper-like products, it is possible to use, besides a paper web of full, half and quarter width, simultaneously also a web having any arbitrary variable width. By means of this it is possible to variably change the total surface of the product continuously, without the original dimensions of the product being changed, such as for example in case of a general web width change of all webs.

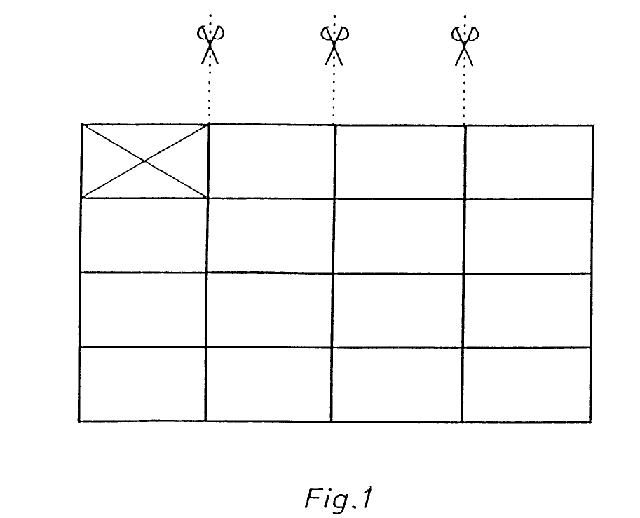

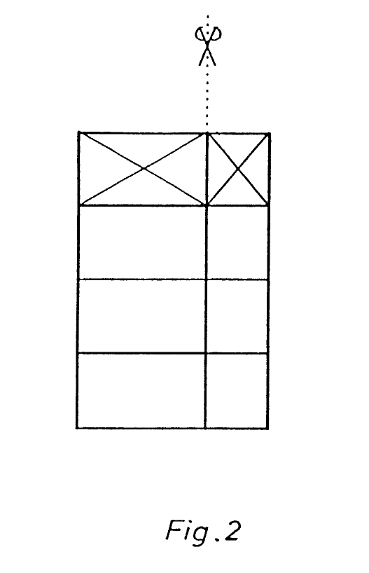

In this connection it has been shown to be technically advantageous to operate with variable web widths between one half and a full web width in case of single-width rotations, and in case of double-width rotations with variable web widths between a quarter and half a web width. The reason for this is that very narrow web widths (narrower than a broadsheet page) are very difficult to handle by machine technology, and that too large a number of different web widths is uneconomical to procure. For example, in a double-width rotation it is possible to achieve the same effect with a ⅜-width and a normally present ½-width web as with a ⅞-width web (FIG. 1, FIG. 2).

The additional web strip of arbitrary width can be employed for all products which can be produced in the newspaper rotation, such as broadsheet products, tabloid products, magazine products, etc., for example, and can be processed with web guide elements customary in newspaper rotation, such as turning bars, mixing arrangements, funnel groups, etc., and with their help can be placed at almost any location in the product. It is moreover possible to attach these width-variable web strips, which are processed into lateral strips of partial width, to the whole product by means of all known aid devices, for example stapling or gluing devices, etc. In the same way it is possible to use and process several webs of variable web width simultaneously.

Exemplary embodiments of the invention are represented in the drawings and will be described in greater detail in what follows.

Shown are in:

FIG. 1, a schematic representation of a material web of a width of four broadsheet pages,

FIG. 2, a schematic representation of a material web of variable width,

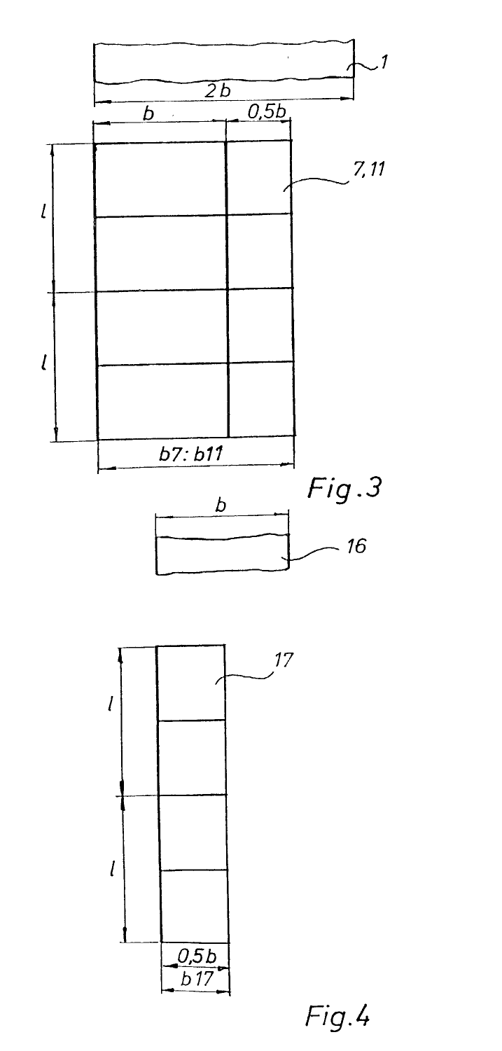

FIG. 3, a schematic representation of a material web in broadsheet format,

FIG. 4, a schematic representation of a material web in tabloid format,

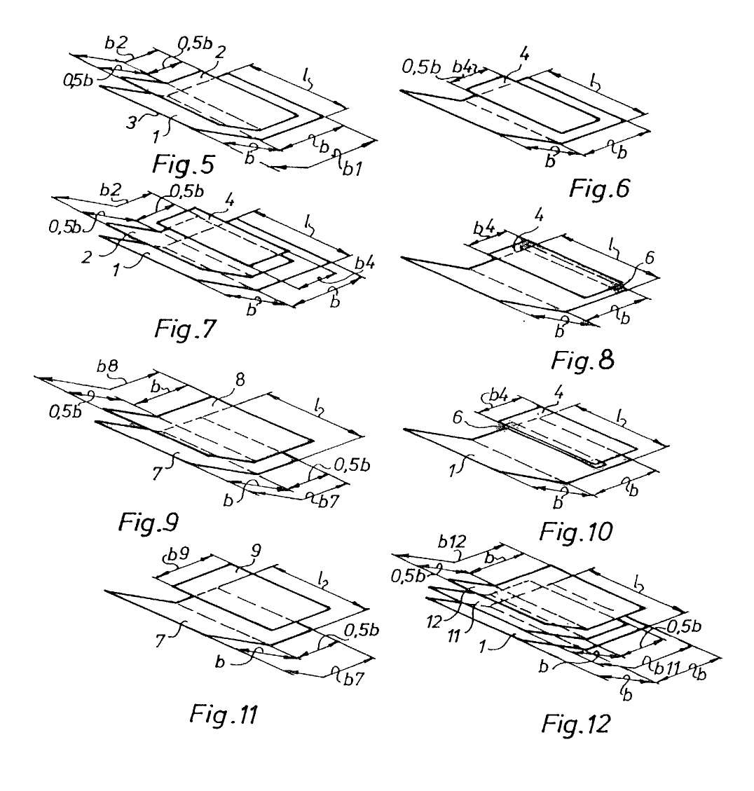

FIGS. 5 to 16, schematic representations of printed products.

Some printed products in a broadsheet format are represented by way of example in FIG. 5 to FIG. 12.

A first material web 1 can be a “single width” material web 1, or a partial material web 1 of a multiple-width, for example double-width, longitudinally cut material web 1. In what follows, the designation material web 1 (FIG. 1) is used for a first material web 1, also for simplification in case it is a cut partial material web.

To produce a printed product of a first exemplary embodiment (FIG. 5), a first material web 1 of a first width b1, for example b1=2b, and a partial material web 2 of a width b2, are brought together.

For example, the width b2=b of the partial material web 2 corresponds to half the width b1 of the first material web 1. The material web 1 and the partial material web 2 are conducted on top of each other in such a way that their outer edges extend parallel and symmetrically in respect to each other.

For example, the material web 1 and the partial material web 2 are longitudinally folded by means of a funnel, not represented, and are subsequently laterally cut at a length (=section length) l. Thus, the printed product has a first page 3, located on the outside, of a format width b times length l.

A double page formed by the partial material web 2, whose individual pages have half the width of the first page 3, is located inside a first double page constituted by the material web 1.

In further exemplary embodiments (FIGS. 6, 7, 8, 10), a partial material web 4 of a width b4, for example b4=0.5 b, is brought to the first material web 1. This partial material web 4 can be brought in, for example, congruently with an outer edge of the first material web 1 (FIGS. 8, 10), or with a provided fold line of the material web 1 (FIGS. 6, 7), and can be fastened, for example by means of an adhesive strip 6, on the first material web 1 (FIGS. 8, 10), or loosely inserted (FIGS. 6, 7).

This partial material web 4 can be brought in additionally (FIG. 7) to the material web 1 and the first partial material web 2 of the first exemplary embodiment (FIG. 5).

FIG. 9 shows an exemplary embodiment in which two partial material webs 7, 8 respectively have widths b7, b8, for example b7, b8=1.5 b. The two partial material webs 7, 8 are offset in respect to each other by b/2 in the direction of the width, so that a longitudinal fold folds the partial material webs 7, 8 asymmetrically.

In FIG. 11, a partial material web 9 of a width b9, for example b9=b, has been inserted into the partial material web 7, so that a left outer edge of the partial material web 9 lies congruently on the fold line of the partial material web 7 and rests on the shorter leg of the partial material web 7.

FIG. 12 shows a printed product in which two partial material webs 11, 12, respectively of a width b11, b12=1.5 b, have been placed on the first material web 1 of a width 2b, so that a left outer edge of the partial material web 11 is approximately congruent with the left outer edge of the material web 1, and a right outer edge of the partial material web 12 is approximately congruent with the right outer edge of the material web 1.

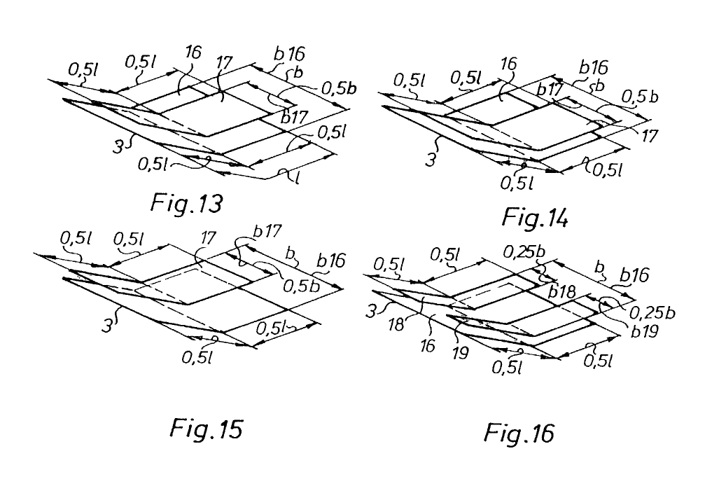

Printed products in tabloid format are represented by way of example in FIGS. 13 to 16.

To make the printed products in FIGS. 13, 14, 15, a material web 16 of a width b16, for example b16=b, and a partial material web 17 of a width b17, for example b17=0.5 b, are brought on top of each other. Subsequently the material web 16 and the partial material web 17, placed on top of each other, are transversely cut into signatures, and are transversely folded, for example by means of a folding jaw cylinder. As represented in FIG. 16, it is also possible to insert several partial material webs 18, 19 of a width b18, b19, for example b18, b19=0.25 b, next to each other and/or on top of each other, into the material web 16.

It is common to all exemplary embodiments, that a maximum format is set by the first, outside located page (title page) of a double page of a signature, and that at least one page of a smaller format than the first page lies inside this folded signature.

Since all printed products are made of brought-together material webs, at least one outer edge of the narrow material web lies neither on an outside edge nor on a fold line of the wide material web.

Measurement and ratio information, as well as the terms “equal to” and “congruent” should be understood in the technical sense, so that tolerances are permissible. These tolerance can appear in the millimeter range, in particular with folded products.

It is possible with the present printed products to selectively surround a block of information which is connected by its contents, for example an advertisement, a group of advertisements, a group of advertisements in the form of a column, or entire, or respectively parts of columns, with longitudinal perforations and transverse perforations, and to cut them out of the printed product in this way.

The multifunctional perforation can be achieved by means of machine technology in the following manner:

Assuming that the newspaper product is designed in the form of a broadsheet product in columns, and all pages are produced with the same column width, the longitudinal perforation device can be arranged at a location at which several, or even all, webs or strands of webs are combined. Because of this, one longitudinal perforation device with several perforation cutters, which can be of variable width transversely to the paper web, is sufficient.

If, however, individual pages are to be differently longitudinally perforated, these pages, or respectively the associated paper web, must be equipped with a separate longitudinal perforation device.

The transverse displacement of the individual longitudinal perforation cutters can be performed manually or automated, and in the extreme case can be performed by remote control.

In the simplest case, the transverse perforation can be uniform for all pages of the product. In this case only one transverse perforation device is required. If all pages only have a single transverse perforation, one transverse perforation cutter is sufficient.

If several transverse perforations are required, the transverse perforation device must be equipped with several transverse perforation cutters. Ideally the transverse perforation cutters are arranged in such a way that they can be varied in number, as well as in the circumferential position, and therefore also in the distances between the perforation lines.

In the extreme case, each page has several transverse perforation lines which are different from page to page, and which can extend over the entire page width or over a partial width of the page, for example a longitudinally perforated column. In this case it is necessary that each paper web be equipped with a transverse perforation device, which contains respectively one transverse perforation cutter per the required number of transverse perforations over the width of the paper web, and per required number of transverse perforations, over a length of the paper web corresponding to a cylinder circumference or half a cylinder circumference.

The cutter holder must be designed such that the respective cutter position can be varied in the transverse and circumferential directions, that different perforation cutters of different widths can be used, and that the number of cutters and their circumferential positions in respect to each other can be varied.

In this case the use of an electronically controlled independent drive mechanism for this perforation device makes the synchronization of perforation and rotation and of an exactly register-maintaining perforation easier.

If the product is made as a tabloid, the “column perforation” is created by means of the transverse perforation device. The perforation which is horizontal in the reading direction in the end product, however, is produced by means of a longitudinal perforation device. If the product is not only to be perforated continuously horizontally, but also perforated partially, for example in columns, the perforating circumference of the longitudinal perforation cutter is divided in accordance with the column width, similar to a skip-slitter cutter.

In order to be able to react as flexibly as possible to different column widths and to columns, which are to be perforated, or respectively not perforated, within the same perforation track, it is necessary that the longitudinal perforation cutter holder can be universally employed. To this end it is necessary that it can be displaced transversely to the web running direction as desired, and can receive different perforation cutters of different circumferential design or, even better, different individual cutter circumference segments at any arbitrary location. Because of this it is possible to create perforation lines of any desired width, which can be interrupted at any desired intervals, at any desired location of the page.

### LIST OF REFERENCE NUMERALS

1 Material web, first

2 Partial material web

3 Page, first

4 Partial material web

5 -

6 Adhesive strip

7 Partial material web

8 Partial material web

9 Partial material web

10 -

11 Partial material web

12 Partial material web

13 -

14 -

15 -

16 Material web

17 Partial material web

18 Partial material web

19 Partial material web

b Width

b2 Width

b4 Width

b7 Width

b8 Width

b9 Width

b11 Width

b12 Width

b18 Width

b19 Width

l Length

1. A method for producing a printed product on a web-fed rotary printing press, wherein a plurality of material webs (1) and/or partial material webs (2, 4, 7, 8, 9, 11, 12) are combined in such a way that at least one outer edge of a partial material web (2, 4, 7, 8, 9, 11, 12) is neither approximately congruent with the outer edges nor with a fold line of a first material web (1), characterized in that at least one material web (1) or a partial material web (2, 4, 7, 8, 9, 11, 12) is longitudinally folded.

2. The method in accordance with claim 1, characterized in that the material web (1) or partial material web (2, 7, 8, 9, 11, 12) is longitudinally folded by means of a funnel.

3. The method in accordance with claim 1, characterized in that a width (b4, b8, b11, b12) of a partial material web (4, 8, 11, 12) is not equal to half the width (b1) of the material web (1).

4. The method in accordance with claim 1, characterized in that the printed product is in “broadsheet format”.

5. The method in accordance with claim 1, characterized in that the first material web (1) and partial material webs (2, 7, 8, 11, 12) are longitudinally folded.

6. The method in accordance with claim 5, characterized in that the outer edges of the first material web (1) and the partial material web (2) are arranged axis-symmetrically in respect to the fold line.

7. The method in accordance with claim 1, characterized in that a fold line divides the partial material web (7, 8, 11, 12) in its width (b7, b8, b11, b12) at an approximate ratio of ¼ to ¾.

8. The method in accordance with claim 1, characterized in that the second partial material web (6) is fastened on the first material web (1).

9. A method for producing a printed product on a web-fed rotary printing press, wherein a plurality of material webs (16) and/or partial material webs (17, 18, 19) are combined in such a way that an outer edge of a second partial material web (17, 18, 19) lies between the two outer edges of the first material web (16), and that at least one material web (16) or partial material web (17, 18, 19) is transversely folded in a first folding process, characterized in that, with the transversely folded printed product, a signature cut off from the second partial material web (17, 18, 19) lies inside a signature cut off the first material web (16).

10. The method in accordance with claim 9, characterized in that the printed product is transversely folded by means of a folding jaw cylinder.

11. The method in accordance with claim 9, characterized in that the printed product has a tabloid format.

12. The method in accordance with claim 9, characterized in that a width (b17) of a partial material web (17) is equal to one half of the width (b) of the first material web (16).

13. The method in accordance with claims 1 and 9, characterized in that a width (b1, b16) of a first material web (1, 16) is greater than a width (b2, b4, b7, b8, b9, b11, b12, b17, b18, b19) of a partial material web (2, 4, 7, 8, 9, 11, 12, 17, 18, 19).

14. A printed product, which consists of one or several material webs (1, 16) and/or partial material webs (2, 4, 7, 8, 9, 11, 12, 17, 18, 19), which are conducted on top of each other in a web-fed rotary printing press, and is transversely cut, as well as folded, and wherein a page (3) lying on the outside has a maximum format of the printed product, characterized in that a page (3) on the inside has a smaller format than the maximum format of the page (3) lying on the outside.

15. The printed product in accordance with claim 14, characterized in that a width (b1, b16) of a first material web (1, 16) lying on the outside is greater than the width (b2, b4, b7, b8, b9, b11, b12, b17, b18, b19) of a second partial material web (2, 4, 7, 8, 9, 11, 12, 17, 18, 19) lying on the inside.

16. The printed product in accordance with claim 14, characterized in that a width (b2, b8, b11, b12, b18, b19) of the second partial paper web (4, 8, 11, 12, 18, 19) is approximately ¼ or ¾ of the width of a first partial paper web lying on the outside.

17. Method and printed product in accordance with claims 1 or 9 or 14, characterized in that a width (b2, b4, b8, b11, b12, b17, b18, b19) of a second partial material web (2, 4, 8, 11, 12, 17, 18, 19) is less than or equal to ¾ of the width (b1) of the first material web.

18. Method and printed product in accordance with claims 1, 9 or 14, characterized in that the printed product is embodied as a newspaper.

19. Method and printed product in accordance with claims 1, 9 or 14, characterized in that longitudinal and/or transverse perforations have been cut in at least one material web (1, 7, 16) or partial material web (2, 4, 8, 9, 11, 12, 17, 18, 19).
